(19) United States
(12) Patent Application Publication
(10) Pub. No.: US 2024/0269597 A1
(43) Pub. Date: Aug. 15, 2024

(54) METHOD FOR CLEANING A FILTER

(71) Applicant: Gebr. Becker GmbH, Wuppertal (DE)

(72) Inventors: Markus DABRUCK, Wuppertal (DE); Christian RADAU, Schwelm (DE); Bernhard RADERMACHER, Korschenbroich (DE); Daniel SIMON, Schwelm (DE)

(73) Assignee: Gebr. Becker GmbH, Wuppertal (DE)

(21) Appl. No.: 18/568,891

(22) PCT Filed: Jun. 8, 2022
(86) PCT No.: PCT/EP2022/065450

§ 371 Date: Dec. 11, 2023

(30) Foreign Application Priority Data
Jun. 23, 2021 (DE) 10 2021 116 263.7

(51) Int. Cl. B01D 46/48; B01D 46/00

(52) U.S. Cl. CPC B01D 46/48; B01D 46/0093

(57) ABSTRACT

A method for cleaning a filter in a filter device having a filter housing and the filter located therein, the filter device including a filtered material collecting chamber to receive filtered material which accumulates during the cleaning of the filter. The filtered material collecting chamber is filled with a fire prevention agent before it first receives filtered material. The filtered material collecting chamber is filled with a solid material over part of the volume of the filtered material collecting chamber. In the course of a removal of the filtered material collecting chamber from the filter device, a targeted exchange of a chamber atmosphere for the surrounding atmosphere is carried out, and in connection with an inflow of atmospheric air, a mixing movement of the filtered material collecting chamber for mixing the filtered material with the solid material is carried out.

### CROSS REFERENCE TO RELATED APPLICATIONS

This application is the National Stage of PCT/EP2022/065450 filed on Jun. 8, 2022, which claims priority under 35 U.S.C. § 119 of German Application No. 10 2021 116 263.7 filed on Jun. 23, 2021, the disclosure of which is incorporated by reference. The international application under PCT article 21 (2) was not published in English.

### TECHNICAL FIELD

The invention relates to a method for cleaning a filter in a filter device having a filter housing and the filter located therein, the filter device having a filtered material collecting chamber for receiving filtered material that accumulates in the course of cleaning the filter.

### PRIOR ART

In metal printing devices, such as fiber sintering or fiber melting devices, further, for example, so-called 3D laser printing devices, it is known to supply process gas to the enclosure of the printing device using a circulation process, which process gas is cleaned or regenerated in a filter device with regard to impurities (for example smoke) resulting in particular from the high heat exposure during the metal printing process, which can arise in particular due to the laser application.

The production of a printed piece in the metal printing device preferably takes place in a protective gas atmosphere achieved by the process gas. For example, an inert gas, such as argon or nitrogen, is generally used as the process gas, with argon or nitrogen further being used as the sole gas. In principle, however, a mixture of gases, thus, inert gases in particular, can also be present as the process or protective gas. In general, the aim is for the atmosphere, in particular in the enclosure, to contain no oxygen or virtually no oxygen. The medium flowing through the filter device is thus the process gas in the case of the metal printing device.

Depending on the size and/or complexity of the printed piece to be produced, such a printing process can well extend over several hours or even several days.

A metal printing device is known, for example, from DE 10 2017 206 792 A1. In connection with a filter device, such a metal printing device has become known, for example, from DE 20 2012 013 036 U1. A method for cleaning a filter is known from DE 10 2015 118 746 A1. Moreover, DE 10 2019 132 349 A1 describes a filter device of the type in question and a method for cleaning the filter.

The filtered material accumulating in the course of cleaning the filter in the filter cleaning process generally consists of a highly reactive material. Accordingly, in the course of disposing of the filtered material, there is an increased risk of ignition when it leaves the protective gas atmosphere provided by the process gas.

In this context, it is known, in particular for smaller systems, to use disposable filters that are disposed of when a predetermined filling level is reached. It is also known to flood in particular disposable filters having a larger holding volume with water and/or oil, whereby a passivation of the filter material is achieved. The disposable filter can then be removed from the housing and disposed of. After cleaning, the housing is fitted with a new disposable filter.

Also known in this regard are solutions in which a fire prevention agent, such as lime or glass granules, is continuously blown into the filter housing so that the entire surface of the filter is wetted and mixed with the material filtered out at the filter. During the cleaning process, this mixture of filtered material and fire prevention agent is transferred to a filtered material collecting chamber. With each cleaning process of the filter, this results in a comparatively relatively high amount of waste, which results in a comparatively frequent emptying of the filtered material collecting chamber.

Cleaning the filter by spraying with oil is problematic with respect to disposal.

Known from DE 10 2006 012 933 A1 is a method for cleaning a filter in a filter device in which the filtered material collecting chamber is first flooded with an inert gas. Known from DE 10 350 395 A1 is a method for cleaning a filter in a filter device, in which the filtered material collecting chamber is filled with additive particles. After reaching a predetermined filling level, the filtered material collecting chamber is exchanged for a new filtered material collecting chamber.

Known from CN 109248508 A is a method for cleaning a filter in a filter device in which the filtered material collecting chamber contains a previously introduced inert material, which can be calcium carbonate powder.

### SUMMARY OF THE INVENTION

Starting from the last-mentioned prior art, the invention is concerned with the object of providing an advantageous method for cleaning a filter in a filter device.

This object is achieved by one aspect of the invention, wherein it is intended that in the course of a removal of the filtered material collecting chamber from the filter device, a targeted exchange of a chamber atmosphere for the surrounding atmosphere is carried out, wherein in connection with an inflow of atmospheric air, a mixing movement of the filtered material collecting chamber is carried out for mixing the filtered material with the solid material.

According to the invention, the fire prevention agent which is already received in the filtered material collecting chamber before the first filter cleaning process of the filter is preferably a prerequisite for controlled passivation of the filtered material, which is to be carried out in a later method step. The fire prevention agent is advantageously received in the collecting chamber receiving the cleaned filtered material prior to a first cleaning process. This quantity of fire prevention agent is sufficient for the total number of cleaning operations for which the collection chamber is designed.

In the course of the reaction, which can be carried out in a controlled manner by the fire prevention agent, there may well be an increase in temperature inside the collecting chamber. However, this temperature increase is so small that the heat can be dissipated to the environment via the housing wall of the collecting chamber.

The filtered material collecting chamber can be closed with a lid that permits a targeted exchange of air with a surrounding atmosphere.

The air exchange takes place with the collecting chamber removed from the filter device and preferably after a first mixing of the chamber contents.

By enabling a targeted air exchange with the surrounding atmosphere, a process can be carried out for passivating the initially reactive filtered material received in the collecting chamber. By means of the air exchange, a targeted oxidation with the atmospheric oxygen from the surrounding atmosphere can be achieved in the collection chamber. The targeted air exchange can be achieved, for example, by actuating a valve provided in the lid. Furthermore, such a valve can also be provided outside the lid, for example connected via a flow line that can form a connection, closed to the environment, between the valve and an opening at the lid that is connected to the interior of the collection chamber.

The filtered material collecting chamber can be rotatable and/or pivotable in a receiving device.

By rotating and/or pivoting the collecting chamber, which is preferably remote from the filter device and is accommodated in the receiving device, a mixing of the filtered material located in the collecting chamber, which supports, for example, a passivation or oxidation process, can be achieved in an advantageous manner. In doing so, the filtered material collecting chamber is preferably rotated and/or pivoted as a whole.

The rotation and/or pivoting or, as preferred, the rotation in a pivoted position of the collecting chamber can thus first be carried out about a body axis corresponding to, for example, a rotation axis of the collecting chamber and, furthermore, preferably about a transverse axis to this body axis. Also, a rotation or pivoting can be carried out about all further geometric axes, which preferably intersect the body axis and/or the transverse axis.

In the case of a superposition of a rotation or pivoting of the collecting chamber about a plurality of geometric axes, a wobbling can occur in the receiving device with respect to the collecting chamber. In addition, jerky rotational and/or pivoting movements or wobbling movements can also occur, for example, when detaching a filter cake that possibly has deposited on the inside of the wall of the collecting chamber.

In connection with the proposed method, the filtered material collecting chamber for fire prevention can preferably be filled with a gas prior to a first filter cleaning operation. In this respect, a gas is preferred which prevents the possible fire hazard of the filtered material accumulated in the collecting chamber. In particular, such a gas prevents uncontrolled oxidation of the reactive filtered material. Furthermore, it is preferably intended that the atmosphere in the collecting chamber contains no oxygen or virtually no oxygen.

In a preferred method, the filtered material collecting chamber is filled with a protective gas for fire prevention. Preferred in this connection is a protective gas, corresponding to the preferred process gas, from which the reactive filtered material is filtered out.

Accordingly, the protective gas is preferably an inert gas, such as argon or nitrogen, wherein, furthermore, argon or nitrogen can preferably be used as the sole gas. In principle, however, a mixture of gases, in particular inert gases, can also be present as the protective gas.

The filtered material collecting chamber is filled with a solid material over part of its volume. The filtered material collecting chamber is already filled with the solid material acting as a fire protection material prior to a first cleaning process of the filter, so that reactive filtered material detached from the filter in the course of a cleaning process is deposited on this base filling. Accordingly, the solid material is not blown into the filter housing and onto the surface of the filter during each cleaning process, as is known, for example, from the prior art, but rather is placed in the collection container in advance in a predetermined quantity prior to a first cleaning process. Accordingly, in the course of cleaning the filter, only the filtered material detached from the filter is preferably placed in the filtered material collection container and only later mixed with the solid material in a downstream process and neutralized in a targeted manner.

In the known method using injection of a fire prevention agent into the collecting chamber, the filtered material continues to be reactive during and after discharge into the environment. Accordingly, the filtered material has still to be securely enclosed with large amounts of fire prevention agent after discharging. In contrast, the proposed method advantageously requires substantially less fire prevention agent compared to the solutions using injection into the filter chamber. Discharging the filtered material is carried out only after complete passivation.

The solid material is preferably filled into the filtered material collecting chamber to about 25% to about 75% of the usable volume of the filtered material collecting chamber before the first use of the collecting chamber, depending on the reactivity of the filtered material.

Furthermore, for example, a filtered material volume of about 15 to 25 cm³ can result after about 10 to 14 hours of operation, preferably about 20 cm³ after 12 hours of operation, in the course of a cleaning that has been carried out. Assuming a maximum permissible filling of the filtered material collecting chamber with about 3,000 cm³ of filtered material, this results in about 120 to 200 permissible filter cleanings or 1,500 to 2,000 operating hours as a change or emptying interval for the collecting chamber. In filter systems with, for example, two filter devices operating in parallel, the time between the cleaning processes is doubled so that, with 120 to 200 permissible cleaning processes per filter device, a total operating time of 3,000 to 4,000 hours is achieved so that accordingly each container only has to be removed and emptied after 3,000 to 4,000 hours. In the case of 7-day operation of the entire system with 90% availability, emptying of a collecting chamber may thus advantageously be required only every 6 months.

The solid material can be in the form of granules. Based on a cross-sectional area by such a granular solid material, a largest preferred dimension of extent (grain size) of the solid is provided, which is preferably smaller than 1 mm, further in particular smaller than 0.5 mm up to, for example, 0.5 mm.

Further, according to a preferred method, a solid material, which is glass-like, can thus be used. For example, it can be a glass granule, for example with a grain size of about 0.1 to about 0.3 mm.

More preferably, the filtered material collecting chamber can be removed from the filter device after a predetermined filling level of filtered material in the filtered material collecting chamber has been reached, and the protective gas can be exchanged for atmospheric gas.

For further preparation of such a reactive filtered material for final disposal, the filtered material collecting chamber is removed from the filter device. Thereafter, the filter device can be equipped with a further collecting chamber, preferably filled again with a fire prevention agent, so that the filter device can be integrated again into the usual cleaning process for the process gas.

In the course of the removal from the filter device, preferably after completion of the removal, the targeted exchange of the chamber atmosphere (protective gas) for the surrounding atmosphere is preferably carried out. In doing so, the protective gas is preferably successively exchanged for ambient air, wherein oxidation and thus passivation of the filtered material is gradually achieved by the atmospheric oxygen penetrating into the collecting chamber in the course of this. Due to the targeted and preferably time-delayed exposure of the filtered material to oxygen, the risk of fire is substantially eliminated.

The filtered material collecting chamber can have a usable storage volume for filtered material of, for example, about 10,000 to 25,000 cm³ or more, further, for example, about 20,000 cm³. In contrast, the total volume can be selected to be larger by, for example, about 20 to 25%.

With respect to the receiving volume, the exchange can be carried out over a period of several hours, such as, for example, about 2 hours or more, further up to, for example, 12 hours or more.

In an advantageous further development of the method, it is provided that in connection with the inflow of atmospheric air, a movement of the filtered material collecting chamber is carried out for mixing the filtered material, preferably the filtered material, with the solid material. Such mixing of the filtered material can initially take place alone and without the inflow of atmospheric air, in order to achieve uniform mixing of the filtered material and the preferably provided solid material. Thereafter, if necessary, a negative pressure can be generated in the filtered material collecting chamber by extracting the protective gas. Via mechanical means, for example a throttle valve, a connection of the interior of the collecting chamber with the surrounding atmosphere can then be achieved, preferably while continuing the mixing, for the targeted or controlled reaction of the filtered material with the atmospheric oxygen.

In doing so, in particular due to intensive mixing with the solid material, only a comparatively small amount of filtered material can react at any given time at the surface of the filtered material/solid material mixture with the atmospheric oxygen flowing very slowly and in a controlled manner into the collecting chamber.

Due to the targeted reaction with atmospheric oxygen, the filtered material is passivated to such an extent that a hazard is excluded during the final disposal of the filtered material.

For the rotating and/or pivoting movement and, if necessary, also for the targeted air exchange with the surrounding atmosphere, a separate receiving device for a filtered material collecting chamber of the type described above can be used, for example.

The filtered material collecting chamber removed from the filter device can be connected to a transport container, in particular after passivation of the filtered material has been carried out, preferably by mixing with solid material and reaction with atmospheric oxygen, wherein, more preferably, the filtered material is transferred directly into a space of the transport container which, in any case, is closed off from the surrounding atmosphere. After passivation of the filtered material, the filtered material collecting chamber is emptied into the transport container, optionally using a receiving device. Such emptying, as is also preferred, can take place solely as a function of gravity, wherein the filtered material collecting chamber is brought, for example, into an overhead position, optionally using the receiving device, and is connected in this position to the transport container. The transfer of filtered material from the collecting chamber into the transport container is preferably carried out in an area closed off from the surroundings. This prevents contamination of the surroundings with escaping filtered material.

Together with the filtered material, the fire prevention agent, for example in the form of a solid material filled into the collecting chamber before a first intake of filtered material, is also disposed of in the course of emptying into the transport container.

Prior to a re-arrangement of the filtered material collecting chamber on the filter device, the filter device is refilled in particular with a fire prevention agent. Thus, prior to such a re-arrangement, a filling with solid body material and/or protective gas can be carried out. Also, such a filling with fire prevention agent can take place, for example, immediately after an arrangement of the filtered material collecting chamber on the filter device.

According to a preferred configuration, the filtered material collecting chamber has a self-closing valve. In particular, in the course of a removal of the collecting chamber from the filter device, this valve closes the opening allowing the passage of separated filtered material into the collecting chamber during normal filter operation. More preferably, a device is provided which can actuate the valve when the filtered material collecting chamber is removed from the filter device for gas exchange with atmospheric gas. This device can be fully or partially formed by the lid or an apparatus formed on the lid.

Moreover, the device can comprise, for example, an apparatus for displacing the valve at the chamber into the open position and moreover, if necessary, a separate valve design, for example in the manner of a throttle valve, for the targeted and controlled intake of air atmosphere into the collecting chamber.

In addition, rod-like handling parts can be formed on the collecting chamber, for example. These handling parts can be used for transporting the collecting chamber after removal from the filter device, for example for manual transport or also for transport by means of a carrier. Moreover, the rod-like handling parts, in particular parts or portions of these handling parts, can be designed for directly or indirectly acting on a releasable latching mechanism securing the mount of the collecting chamber to the filter device.

### BRIEF DESCRIPTION OF THE DRAWINGS

The invention is explained in more detail below with reference to the accompanying drawing which merely shows an exemplary embodiment. In the figures:

FIG. 1 shows a schematic perspective illustration of a metal printing device with an associated filter module, comprising multiple filter devices;

FIG. 2 shows a perspective illustration of the arrangement of three filter devices fluidically connected in parallel, with a circulation fan and a medium cooler;

FIG. 3 shows a schematic sectional view through a filter device according to line III-III in FIG. 2, relating to a method step for filtering a medium flowing through the filter device;

FIG. 4 shows a sectional view according to FIG. 3, but relating to an offset sectional plane;

FIG. 5 shows a sectional view through the filter device corresponding to FIG. 3, relating to a method step for evacuating the interior of a filter housing;

FIG. 6 shows a sequential illustration of FIG. 5, relating to a method step for cleaning a filter in the filter housing of the filter device;

FIG. 7 shows a sequential illustration of FIG. 6 after completion of the cleaning process and transfer of filtered material into a filtered material collecting chamber;

FIG. 8 shows the enlargement of region VIII during removal the filtered material collecting chamber from the filter housing;

FIG. 9 shows the filtered material collecting chamber in individual perspective view with an assignable cover;

FIG. 10 shows the filtered material collecting chamber removed from the filter device in an arrangement position on a transport vehicle in the course of approaching a receiving device;

FIG. 11 shows the filtered material collecting chamber placed in the receiving device;

FIG. 12 shows the filtered material collecting chamber pivoted into a mixing position in the receiving device;

FIG. 13 shows the mixing position of the filtered material collecting chamber in a schematic vertical sectional view;

FIG. 14 shows a perspective cross-sectional view through the filtered material collecting chamber;

FIG. 15 shows a sequential illustration of FIG. 12, relating to the filtered material collecting chamber in the course of the passivation of the chamber contents;

FIG. 16 shows a sectional view corresponding to FIG. 13, relating to a position of the collecting chamber in the course of the passivation according to FIG. 15;

FIG. 17 shows the receiving device with the filtered material collecting chamber brought back after the passivation to the placement orientation according to FIG. 11;

FIG. 18 shows the filtered material collecting chamber filled with passivated filtered material in another arrangement position on the transport vehicle during pickup of the collecting chamber from the receiving device;

FIG. 19 shows a sequential illustration of FIG. 18 after the filtered material collecting chamber has been turned to an emptying position;

FIG. 20 shows a sequential illustration of FIG. 19 after lifting the filtered material collecting chamber;

FIG. 21 shows a situation in the course of bringing the filtered material collecting chamber to a transport container using the transport vehicle;

FIG. 22 shows a situation in the course of docking the filtered material collecting chamber to the transport container;

FIG. 23 shows the emptying situation;

FIG. 24 shows the situation following FIG. 23, after emptying has been completed;

FIG. 25 shows the emptied filtered material collecting chamber in the transport vehicle after it has been turned back to the starting position and reapproaching the receiving device for filling the collecting chamber with a solid material;

FIG. 26 shows the filling situation after docking of the collecting chamber to a storage container provided in the receiving device;

FIG. 27 shows the situation after filling the collecting chamber with solid material and lowering the filter device;

FIG. 28 shows the return transport situation of the collecting chamber filled with solid material back to the filter device;

FIG. 29 shows a schematic sectional view through the filter device according to FIG. 3 after re-arrangement of the filtered material collecting chamber on the filter device.

### DESCRIPTION OF THE EMBODIMENTS

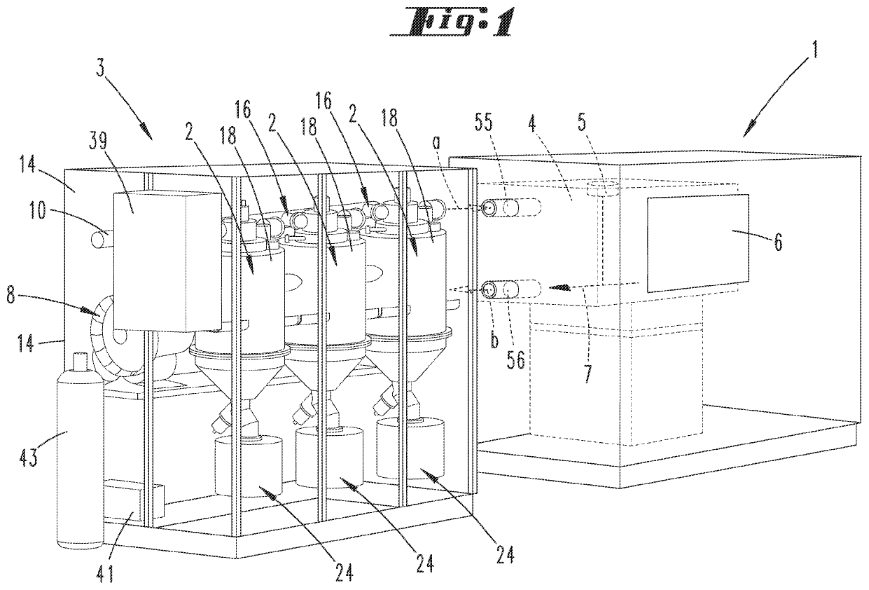

Illustrated and described, in first instance with reference to FIG. 1, is a metal printing device 1 with an associated filter module 3 having a multiplicity of filter devices 2.

The metal printing device 1 has first and foremost an enclosure 4 in which the metal printing process can be carried out. In this case, as a result of selective laser melting, a desired component is produced layer by layer from fine metal powder under the action of a laser beam. The production can be based here directly on so-called 3D-CAD data such that fully functional can components be manufactured from high-quality metals.

In addition to the laser device 5, which is shown only schematically in FIG. 1, an application device for applying a metal powder layer is also substantially part of the printing device, as is a powder storage container, and also a powder collection container into which excess particles can be stripped.

The production of the metal part is carried out in an enclosure 4 which is closed on all sides, for which purpose the enclosure can optionally be provided with a door 6 or the like which closes the enclosure 4.

With regard to the manufacturing process, reference is made, for example, to DE 10 2017 206 792 A1 cited at the beginning.

During the printing process, regeneration of the atmosphere in the enclosure 3 preferably takes place. For this purpose, a gaseous process gas 7, which is preferably a protective gas such as argon or nitrogen, is preferably blown into the enclosure 4 in a circulation process and simultaneously extracted. A fan 8, for example in the form of a circulation fan, is preferably used for this purpose. The fan 8 can be a so-called side channel compressor or the like.

In the illustrated exemplary embodiment, the fan 8 is arranged in the filter module 3 in spatial association with the filter devices 2.

With regard to the method for cleaning the filter as well as with regard to the design of the filter device, reference is made to the document DE 10 2019 132 349 A1 mentioned at the beginning. The disclosure content of this patent application is also hereby included in full in the disclosure of the present invention, including for the purpose of incorporating features of this patent application in claims of the present invention.

As can further be seen, in particular also from the schematic illustration in FIG. 1, the fan 8 is fluidically connected to the interior of the enclosure via a pressure line 9 and a suction line 10 as well as an inlet 55 and an outlet 56.

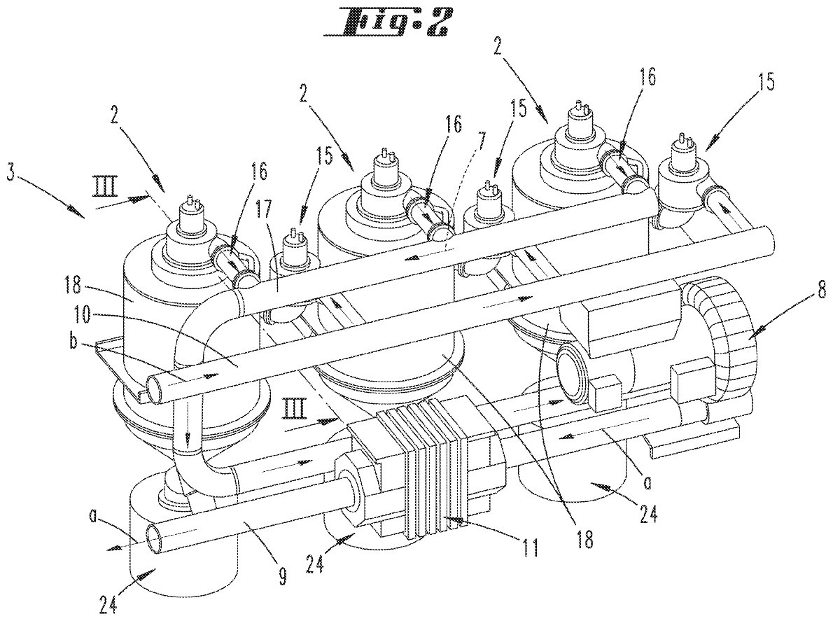

Here, the pressure line 9, extending from the fan 8, can lead directly into the enclosure 3, if necessary, with interposition of a medium cooler 11, as shown in FIG. 2, and preferably assigned to a ceiling region of the enclosure 3. In operation, a direction a of the pressure flow of the medium 7 occurs in the pressure line 9.

At least one filter device 2 is looped into the suction line 10 upstream of the fan 8, corresponding to a direction of flow of the process gas 7. According to the exemplary embodiment shown, multiple filter devices 2, here three of them, can be provided.

The filter devices 2 together with the fan 8 and the possibly provided medium cooler 11, and furthermore, if necessary, with an optionally provided pre-separator 12 and/or a micro filter 13, can be arranged in the filter module 3 in a combined manner. This filter module 3 can include a filter housing 14 which comprises the elements described above. There may be only two interfaces associated in each case with the pressure line 9 and the suction line 10.

A possibly provided pre-separator can be provided upstream of the one filter device 2 or the multiple filter devices 2, as viewed in the direction of flow of the process gas 7, while a micro filter 13 can be provided downstream with respect to the filter device 2 in the direction of flow.

In a usual production process and an associated process gas circulation, a direction b of the suction flow occurs in the suction line 10.

The filter devices 2 are preferably provided in substantially identical design, in this case each having one medium inlet 15 and one medium outlet 16. Each filter device 2 is preferably directly connected to the suction line 10 via the respective medium inlet 15. The medium outlets 16 of the filter devices 2 lead into a suction transfer line 17, which leads to the fan 8, possibly with interposition of the micro filter 13 (see in particular FIG. 2).

The micro filter 13 can also be provided, for example, in the flow direction at the end of the pressure line 9, and possibly also in the flow direction downstream of the medium cooler 11.

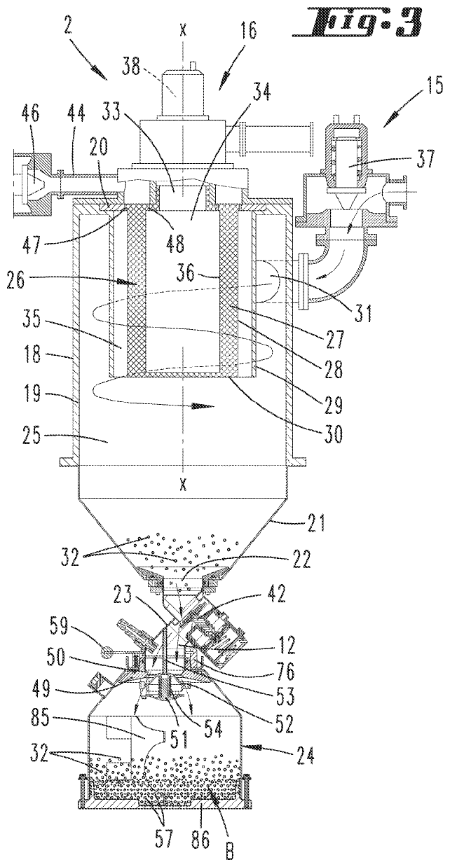

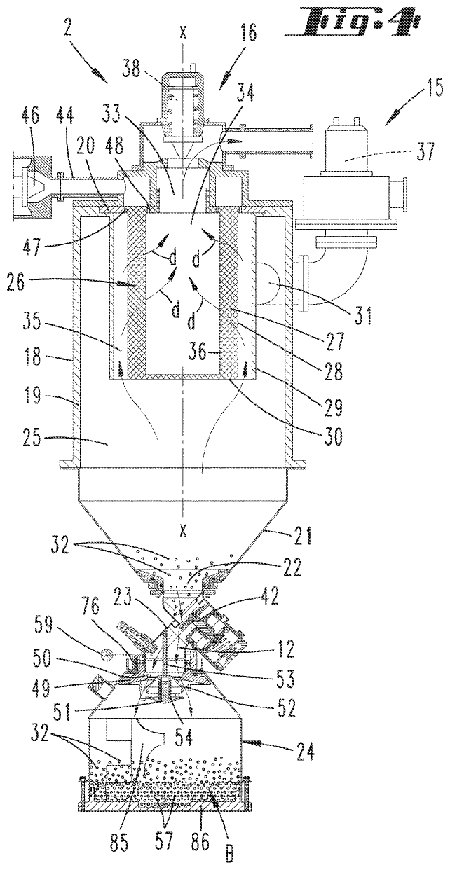

FIGS. 3 and 4 each show a vertical sectional view—with respect to the usual operating position of the filter device 2—through one of the filter devices 2 in regeneration mode, in which filtering of the medium 7 discharged from the enclosure 4 and, for example, contaminated by smoke, is carried out.

As can be seen, for example, from the sectional view in FIG. 3, the filter device 2 can have an approximately circular-cylindrical filter housing 18 with a circumferential housing wall 19 and a housing ceiling 20. The housing base 21 can be funnel-shaped with a central base opening 22 to which a gate portion 23 to a filtered material collecting chamber 24, which can be removed from the filter housing 18, can be connected.

A gate valve 51 loaded into a closed position via a compression spring 54 is arranged between the filter housing 18 and a channel portion 12 formed in the gate portion 23.

According to the illustration, a filter 26 projecting into the interior 25 of the filter housing 18 can be arranged on the underside of the housing ceiling 20. The filter wall thereof, as also shown, can be of tubular, circular-cylindrical design, with a central longitudinal axis x which, in the usual arrangement position, is oriented along a vertical line. In accordance with the illustrated exemplary embodiment, the longitudinal axis x of the filter 26 can also form the central longitudinal axis of the filter housing 18 as a whole.

The filter 26 is surrounded, at a distance from the outer surface 28 of the filter wall 27, by a guide wall 29 which is preferably aligned concentrically with respect to the longitudinal axis x. This guide wall 29, like the filter 26, is virtually suspended from the underside of the housing ceiling 20 and is preferably connected thereto in a flow-tight manner. Viewed in the axial direction, the annular space 35 resulting between the guide wall 29 and the filter wall 27 is open towards the interior 25, while the corresponding end face 30 of the filter 26, which points downwards in normal operation, is formed such that it cannot be penetrated by the flow, in particular by the process gas 7. Filtered material 32 separated in this manner can fall, solely driven by gravity, through the base opening 22 of the housing base 21, pass through the channel portion 12 of the gate portion 23, and into the collecting chamber 24. In this regard, a gate valve 51 provided between the gate portion 23 and the receiving chamber of the collecting chamber 24 is held in an open position.

The inlet opening 31 of the medium inlet 15, as is also preferred, can be provided in the housing wall 19, so that an at least approximately tangential inflow of the medium 7 into the interior 25 of the filter housing 18 can arise, whereby in first instance a vortex-like pre-separation of filtered material 32 is achieved (compare FIG. 3). Here, the filter device 2 initially acts in the manner of a cyclone separator, in which the process gas flow, starting from the inlet opening 31, is guided in a vortex-like manner in the annular space resulting between the guide wall 29 and the housing wall 19.

According to the exemplary embodiment illustrated, the outlet opening 33 of the medium outlet 16 can be provided in the region of the housing ceiling 20, in particular, as is also preferred, centrally, taking up the longitudinal axis x and furthermore being assigned to the filter interior 34 enclosed by the filter wall 27.

As a result of the suction flow arising in normal operation (filter operation) of the filter device 2, the process gas 7 sucked into the interior 25 is sucked from below into the annular space 35 between the filter wall 27 and the guide wall 29 after the vortex-like deflection assigned to the downwardly facing end face 30 of the filter 26, whereupon a penetration of the filter wall 27 from the outer surface 28 to the inner surface 36 of the filter wall 27 occurs (see arrows d in FIG. 4), so that the filtered medium 7 reaches the filter interior 34 and exits the filter device 2 via the outlet opening 33 (compare FIG. 4).

Filtered material 32 separated in the process of this can adhere in the filter wall 27. Any filtered material 32 that falls off through the annular space 35 in the course of this filtering process is preferably collected in the filtered material collecting chamber 24.

Before start-up, the filtered material collecting chamber 24 is filled with a solid material 57, for example in the form of a glass granulate, as a fire prevention agent B, so that in particular the base of the collecting chamber 24 is covered by said fire prevention agent B.

As can be seen from the sectional views, for example in FIGS. 3 and 4, the medium inlet 15 and the medium outlet 16 can each be provided with a shutoff valve 37 and 38, respectively, so as to remove the filter device 2 from regeneration mode after shutoff with respect to the suction line 10 and the suction transfer line 17. In such a state, the regeneration of the process gas 7 with the metal printing device 1 still being in operation is taken over solely by the further filter devices 2 of the filter module 3. In this manner, at least approximately continuous operation of the metal printing device 1 can be ensured even in the event of a failure or deliberate shutoff of a filter device 2, for example for cleaning the same.

For this purpose, the preferably pneumatically operable shutoff valves 37 and 38 of the medium inlet 15 and the medium outlet 16 are brought into a shutoff position. The control of the shutoff valves 37 and 38 in this respect can, and preferably does, take place via control electronics 39 which are not shown in more detail and which can also be part of the filter module 3.

For cleaning the filter 26 in the filter device 2 and for removing the filter cake settling on the filter wall 27 in the course of filtering the process gas 7, the filter device 2 can be set to a regeneration mode. For this purpose, as described above, the filter device 2 is first removed from the flow of process gas or is shut off from the lines by closing the shutoff valves 37 and 38 and thus closing the medium inlet 15 and the medium outlet 16.

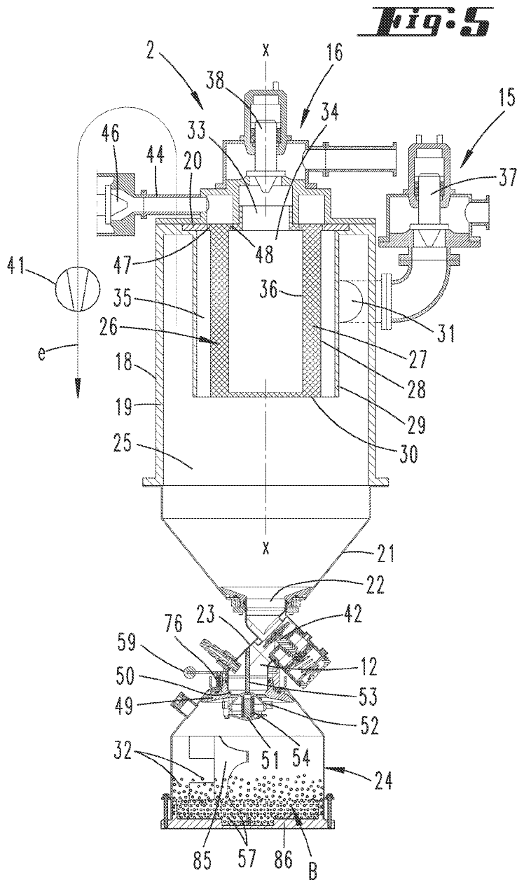

In preparation for the cleaning process, a negative pressure is first produced in the filter housing 18 via a separate pump, in particular vacuum pump 41. In doing so, the interior 25 of the filter housing 18 and also the interior of the filtered material collecting chamber 24, which is open towards this interior 25 (see schematic illustration in FIG. 5—arrow e), are evacuated.

The vacuum pump 41, which can preferably also be part of the filter module 3, can be, as is furthermore preferred, an oil-lubricated vacuum pump, for example, such as the one known from, for example, DE 10 2015 107 721 A1.

Upon reaching a negative pressure of, for example, 500 mbar up to, for example, 1 mbar in the region of the interior 25 (detectable via a pressure sensor), the suction process via the vacuum pump 41 is stopped via the control electronics 29 and thereafter, a discharge valve 42 arranged, for example, in the region of the gate portion 23 between the filter housing 18 and the filtered material collecting chamber 24, is closed. The discharge valve 42 interrupts the line connection between the interior of the filter housing 18, which includes the filter 26, and the interior of the filtered material collecting chamber 24.

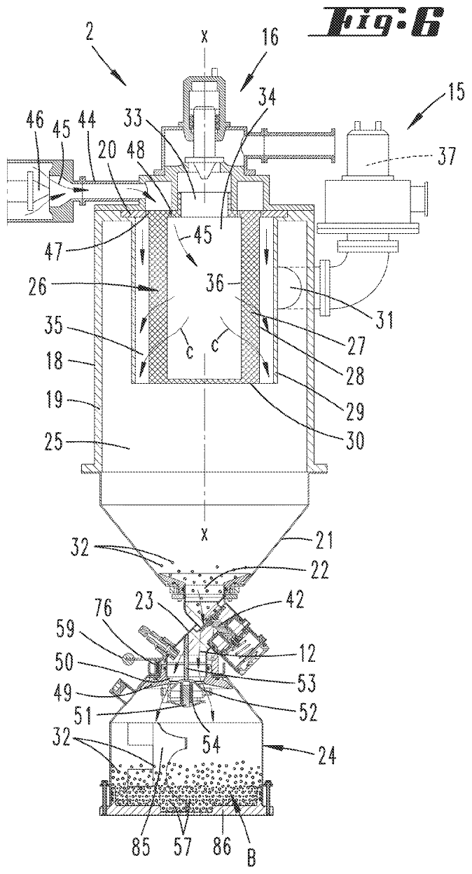

Via a separate flushing medium reservoir 43, which can also be part of the filter module 3, a flushing medium 45 is introduced towards the filter wall 27 via a flushing line 44 for cleaning the filter 26. Introducing the flushing medium 45 can be triggered by a preferably electrically actuated control valve 46 (see FIG. 6). The control valve 46 can be controlled via the control electronics 39.

As a result of, for example, a plurality of flushing medium inlets 47 and 48 provided around the longitudinal axis x in the housing ceiling 20, the flushing medium 45 can be introduced, wherein, according to the illustrations, the flushing medium 45 is introduced into the filter interior 34 via the flushing medium inlets 48 in such a manner that it passes through the filter wall 27 in a direction c opposite to the throughflow direction of the medium 7 in normal filter operation (direction d—compare FIG. 4). Accordingly, penetration of the filter wall 27 by the flushing medium 45 from the inner surface 36 towards the outer surface 28 is thus achieved.

At the same time or also delayed with respect to the flow described above, the flushing medium 45 is introduced via the radially outer flushing medium inlet 47 substantially along the outer surface 28 of the filter wall 27 (direction f) in order to reliably remove in this manner the filtered material 32, which has been loosened in particular via the flushing medium portion passing through the filter wall 27 from the inside to the outside, from the suction region towards the housing base 21.

The introduction of the flushing medium 45 can be achieved solely as a result of suction due to the negative pressure prevailing in the interior 25 of the filter housing 18 relative to the surroundings but can also be achieved in combination therewith by blowing the flushing medium 45 into the interior 25, if needed. The negative pressure in the interior 25 ensures a favorable flow of flushing medium across and through the filter wall 27.

At the end of the cleaning process, the same pressure as in the connected lines (suction line 10 and suction transfer line 17) preferably prevails again in the interior 25 of the filter housing 18, so that when the shutoff valves 37 and 38 are opened, whereby in the case of this example the reintegration of the cleaned filter device into the filter process is achieved, no backflow takes place against the usual flow direction of the process gas 7.

Preferably, the same medium is used as flushing medium 45 which is also used as process gas for removing contaminants in the enclosure 4 of the metal printing device 1. For example, argon and/or nitrogen are/is preferably used as flushing medium 45.

By re-evacuating, a second cleaning process can also be carried out immediately after a first cleaning process, if necessary.

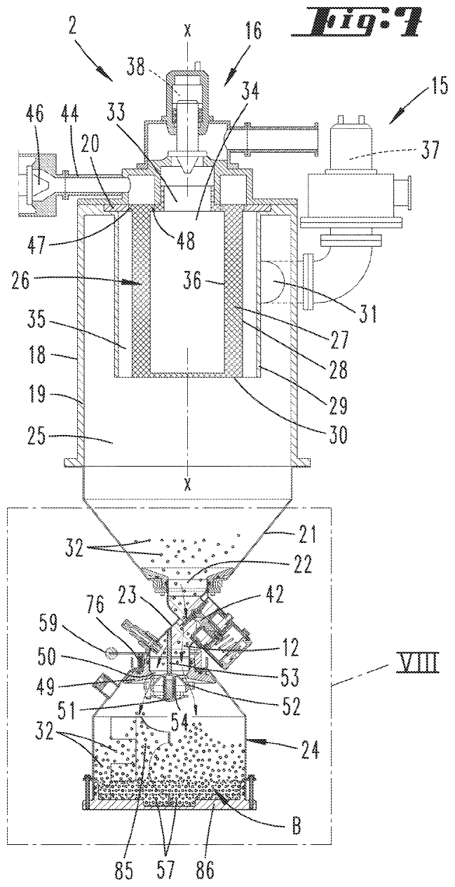

Upon completion of the cleaning process and the accompanying pressure equalization in the interior 25 of the filter housing 18, a pressure difference between the interior 25 and the interior of the filtered material collecting chamber 24 occurs, which, when opening the discharge valve 42, causes the filtered material 32 that was loosened during the cleaning process and preferably collected at the housing base to be sucked into the filtered material collecting chamber 24. Accordingly, the mere opening of the discharge valve 42 triggers a transfer of the loosened filtered material 32 into the collecting chamber (compare FIG. 7—arrow g). The suction process continues until the pressure between the interior 25 and the collecting chamber 24 is equalized. In addition, filtered material 32 can also trickle into the collecting chamber 24 in a gravity-dependent manner.

From this filtered material collection position according to FIG. 7, the filter device 2 can be reintroduced into the filter circuit of the filter module 3 after opening the shutoff valves 37 and 38 in the medium inlet 15 and in the medium outlet 16 (cf. FIG. 15).

For the disposal of the filtered material 32 collected in the filtered material collecting chamber 24 from preferably a plurality of filter cleaning processes, the filtered material collecting chamber 24 can be removed from the filter housing 18. For this purpose, the tubular free end of the gate portion 23 can be designed to accommodate a sleeve portion 49 of the collecting chamber 24 in a flow-tight manner (compare FIG. 8). The chamber opening 50 surrounded by the sleeve portion 49 can preferably be closed by means of the gate valve 51. In the docking position of the collecting chamber 24 on the filter housing 18 as shown in FIG. 7, a valve cone 52 directed towards the gate portion 23 can be directly supported on a holding-down means 53 in the region of the gate portion 23, so that the gate valve 51 is held in a position exposing the chamber opening 50. The holding-down means 53 can extend in a finger-like manner according to the illustrations, thereby passing through the channel portion 12.

In the course of removing the filtered material collecting chamber 24 from the gate portion 23, for example by unscrewing or further, for example, by releasing the latching mechanism, the valve cone 52 loses its support on the holding-down means 53 of the gate portion 23, as a result of which the gate valve 51 automatically falls into a position closing the chamber opening 50 under the action of a compression spring 54.

Preferably, removal of the filtered material collecting chamber 24 takes place with the discharge valve 42 closed, so that when the collecting chamber is removed, the atmosphere in the interior 25, substantially formed by the medium 7, is maintained. Also, by shutting off the interior of the filtered material collecting chamber by the gate valve 51, the filtered material 32 accommodated therein remains under process gas atmosphere, accordingly under an atmosphere formed by the process gas 7 or the flushing medium 45.

After an optionally predetermined number of cleaning cycles, the filtered material collecting chamber 24 is removed from the filter device 2 and the contents (collected reactive filtered material 32 and solids material 57 or fire prevention agent B) are sent for disposal. Upstream of this disposal, there is a station for passivation of the filtered material 32.

Further, the collecting chamber 24 can have rod-like handling parts 59 aligned transverse to the longitudinal axis x on the outside of the wall, for example in the region of the sleeve portion 49. These handling parts 59 can serve to transport the collecting chamber 24 by hand or by means of a vehicle 60. In addition, a portion of the handling parts 59 can be formed as a handle 77 slidingly displaceable transverse to the longitudinal axis x for acting on a slider 73 serving to latch the filtered material collecting chamber 24 to the gate portion 23. By pulling the handle 77 radially outwards—with respect to the longitudinal axis x—the latching mechanism can be released.

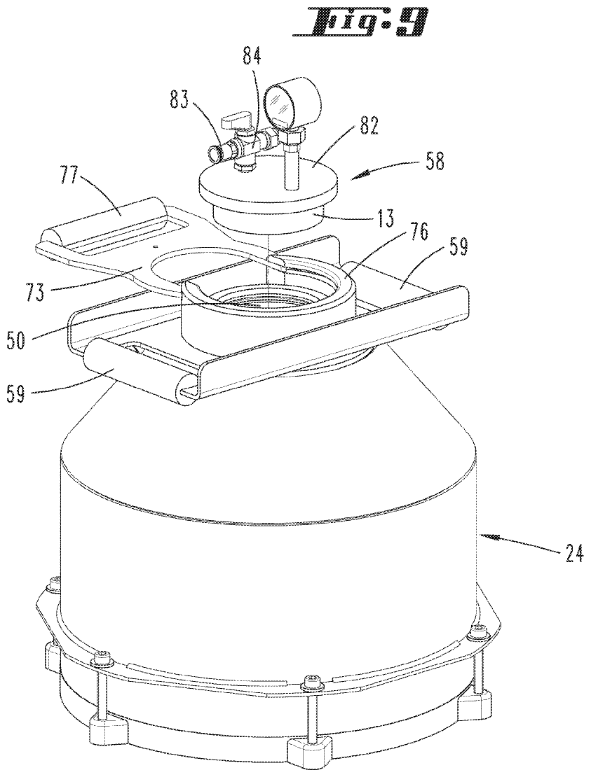

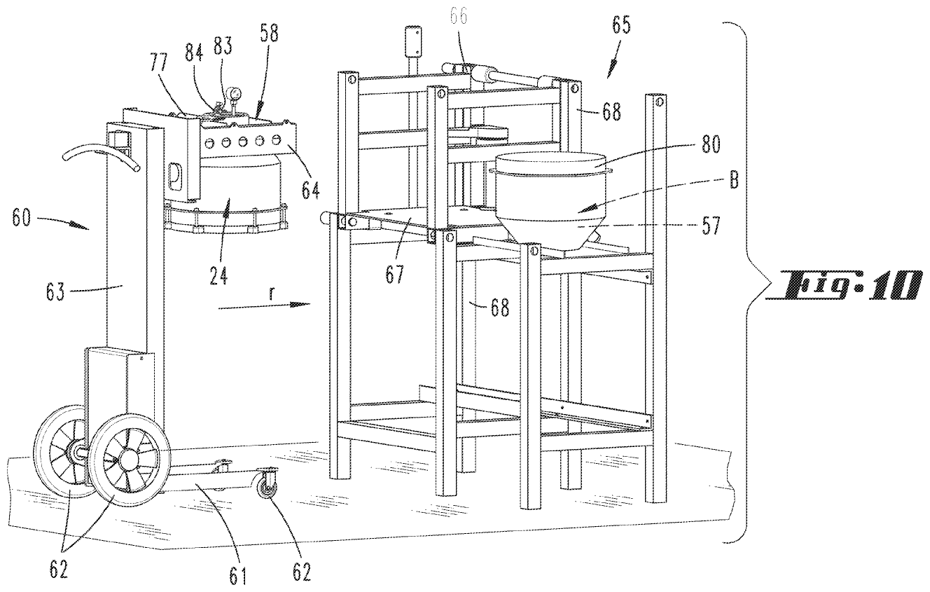

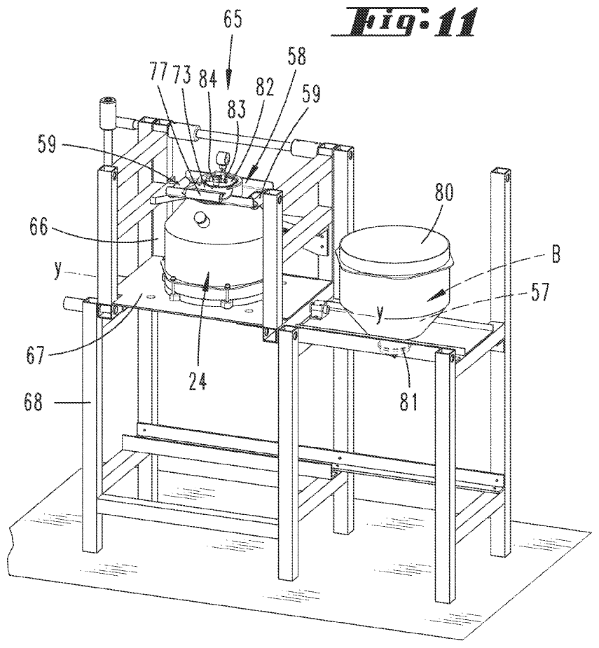

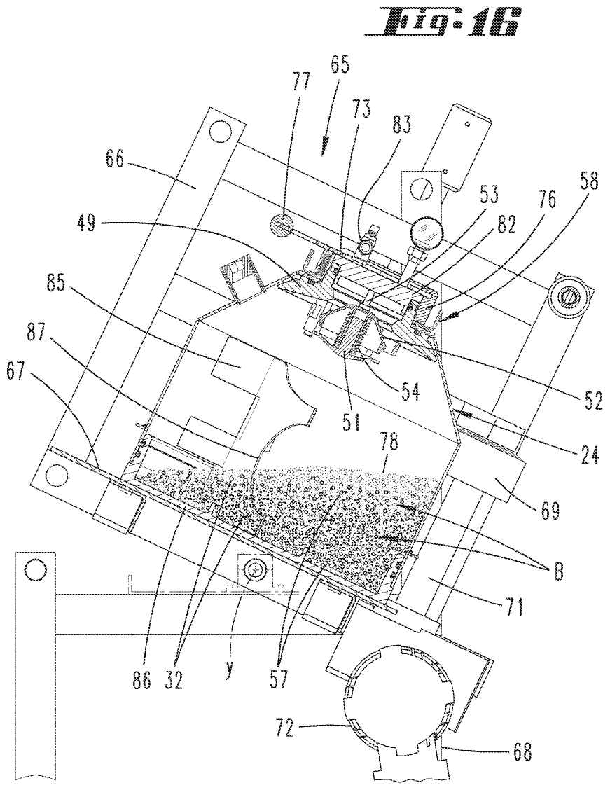

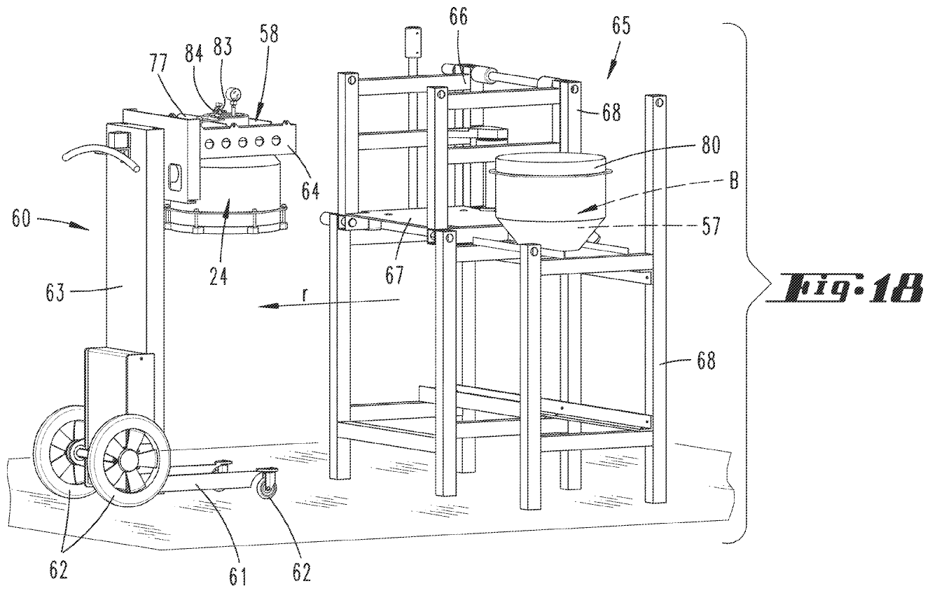

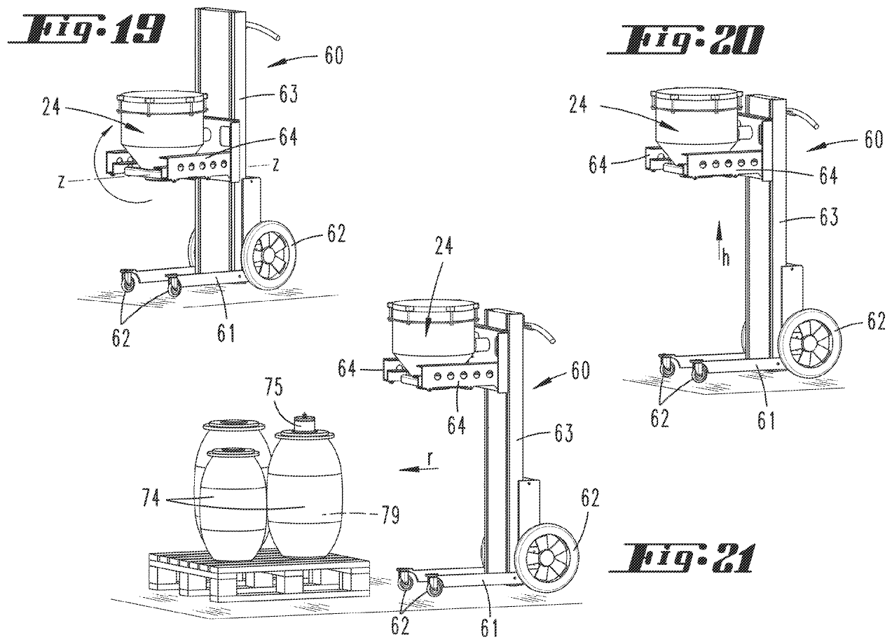

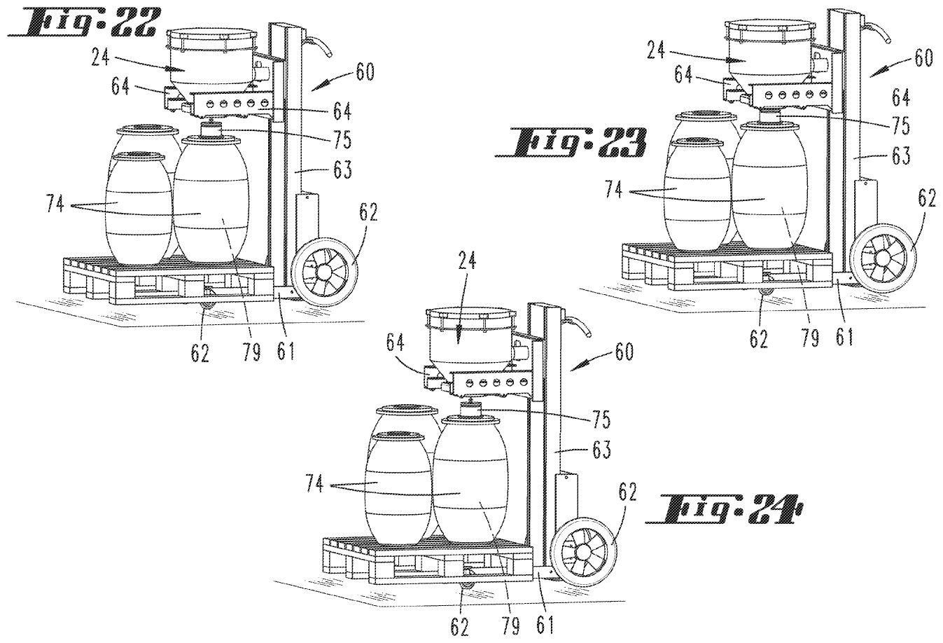

As shown in FIGS. 10 and 18 to 28, transport of the collecting chamber 24 removed from the filter device 2 using a forklift-like vehicle 60 is preferred.

The vehicle 60 preferably comprises a near-ground chassis 61 having wheels 62. A lift mast 63 is mounted on the chassis 61 in substantially vertical alignment, along which substantially horizontally aligned fork arms 64 are arranged to be displaceable in vertical direction, for example driven by a lifting chain. The fork arms 64 are designed for securely gripping the collecting chamber 24, in particular the handling parts 59 thereof. In this respect, for example, a clamping or latching mechanism can be provided for gripping the handling parts 59.

As can be seen, the vehicle 60, as shown in FIG. 10, grips the collecting chamber 24 in the region of the handling parts 59. With this gripping, a possibly provided latching of the collecting chamber 24 onto the gate portion 23 of the filter device 2 can be released so that thereafter, the collecting chamber 24 can be transported by means of the vehicle 60.

In the course of removing the filtered material collecting chamber 24 from the gate portion 23 or, if necessary, immediately thereafter, the chamber opening 50 can be closed with a separate lid 58 by actuating and moving back the slider 73.

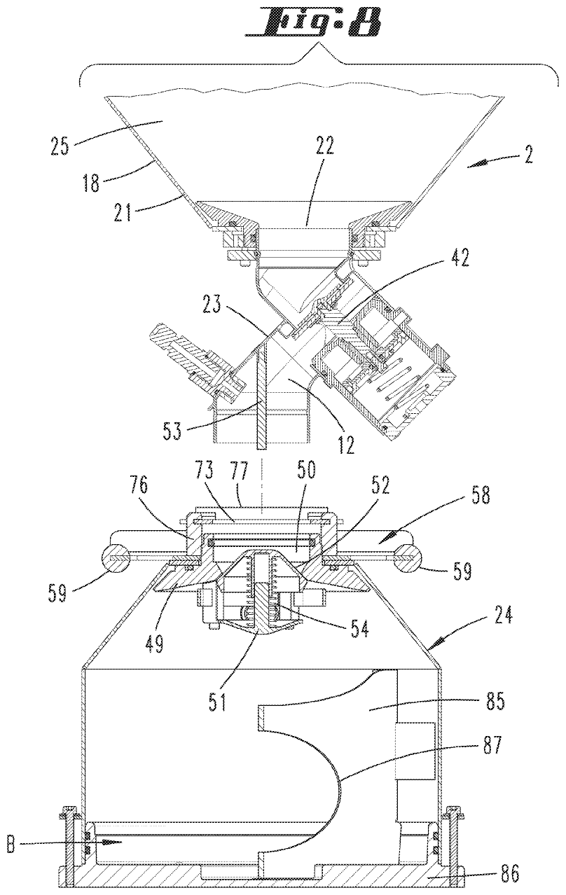

The lid 58 is designed for closing the chamber opening 50 of the filtered material collecting chamber 24, for which purpose the lid 58 first and foremost has a pot portion 13 which has an outer diameter adapted to the diameter of the chamber opening 50 in the region of the sleeve portion 49 and which is preferably integrally formed, and more preferably integrally formed from the same material, on the underside of a plate-like lid portion 82 which, in the closed position, is supported on the facing collar 76 of the sleeve portion 49 (compare FIG. 9).

The lid 58 is penetrated by a pipeline 83, which—when the gate valve 51 is open—connects the interior of the collecting chamber 24 to a pump, for example a vacuum pump, via a further connected line.

A shutoff valve 84, as is also preferred, can be provided in the pipeline 83.

The filtered material collecting is chamber 24 preferably fed to a station 65. This station 65 preferably serves to passivate the contents of the collecting chamber, and, as is also preferred and illustrated, can further include a fire prevention agent storage for filling the collecting chamber 24 prior to a start-up of the collecting chamber 24.

Thus, the station 65 can include a receiving device 66 into which the filtered material collecting chamber 24, preferably transported by the vehicle 60, can be placed.

The receiving device 66, as also shown, can be formed in a grid box-like manner, preferably comprising a placement base 67 and an insertion or removal opening directed towards a front side of the station 65.

Furthermore, the receiving device 66 is mounted on the base frame 68 of the station 65 to be pivotable about a preferably horizontally oriented pivot axis y. The pivot axis y preferably extends transverse to an approach direction r of the vehicle 60 in the course of an approach to the station 65 (compare FIG. 10). Moreover, the pivot axis y preferably extends substantially in the center of the placement base 67, passing therethrough or extending below the placement base 67. The relevant axle body is supported on a crossmember in the middle of the placement base 67 and, moreover, is mounted in this region.

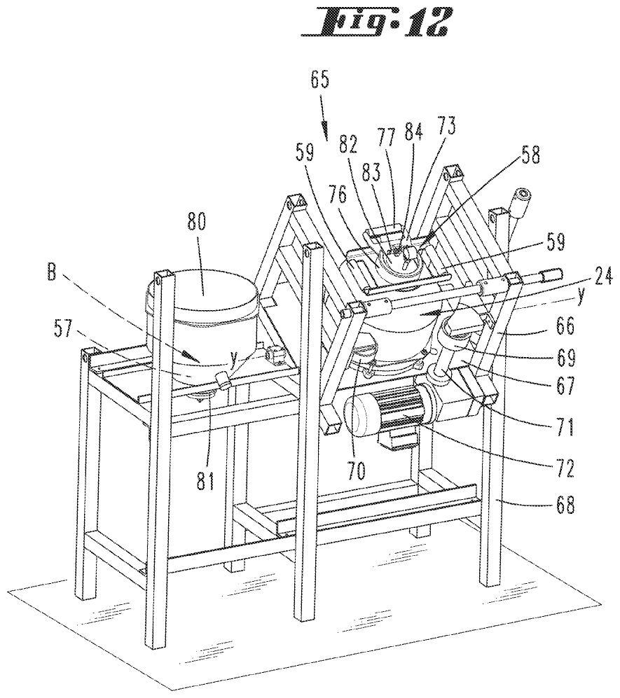

The basic position of the receiving device 66, in which basic position the placement of the collecting chamber 24 on the placement base 67 or the removal of the collecting chamber 24 is also carried out, is preferably stop-limited, as is also possibly a pivot position according to FIG. 12. In this pivot position, as is also preferred, a pivoting of the collecting chamber 24 about the pivot axis y oriented transverse to its longitudinal axis x of about 45 degrees can be achieved (see also FIG. 13).

In this pivot position, the collecting chamber 24 can rest with its preferably circular cylindrical outer wall against at least one drive roller 69 and a support roller 70. The geometric axes of rotation of these rollers 69 and 70 are preferably directed perpendicular to the plane of the placement base 67 and thus in parallel alignment with the longitudinal axis x of the collecting chamber 24.

The drive roller 69 can be actively driven via a shaft 71, for example (as can be seen in particular from the illustrations in FIGS. 12 and 13) by an electric motor 72. The collecting chamber 24, which is supported in particular by its weight on the rollers, can thus be rotated about the longitudinal axis x, in particular in the pivoted position, as a result of the drive of the drive roller 69.

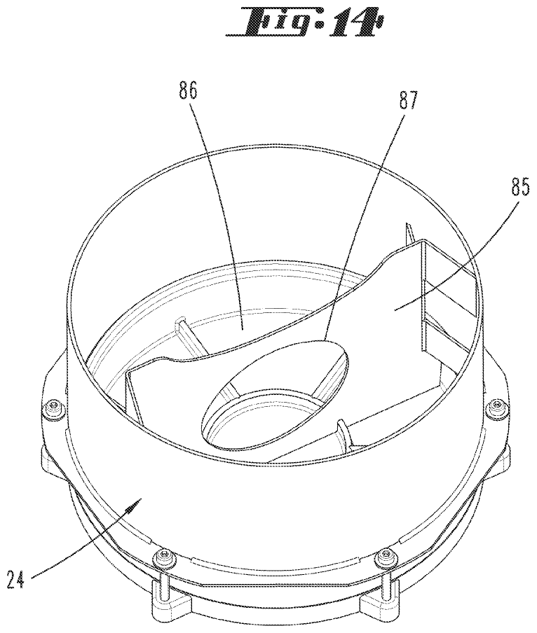

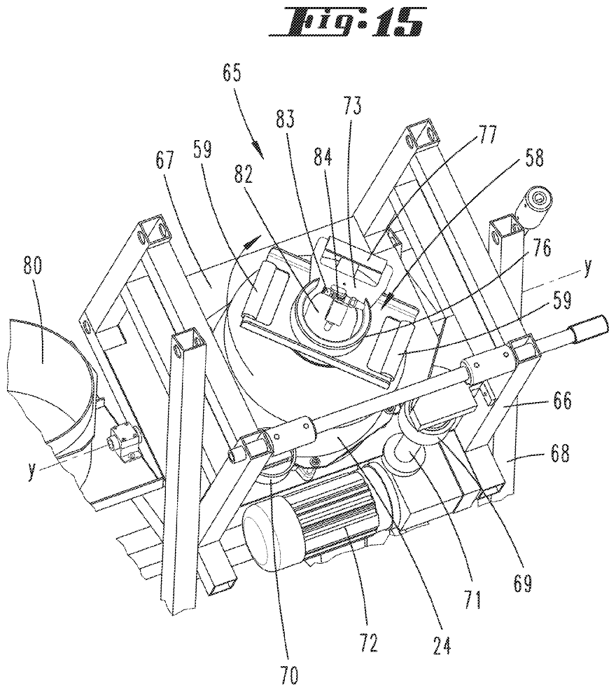

As can be seen in particular from the schematic illustration in FIG. 16, with such a rotation of the collecting chamber 24 about its longitudinal axis x in the pivot position, a substantially uniform mixing of solid material 57 and filtered material 32 is achieved in a first mixing cycle.

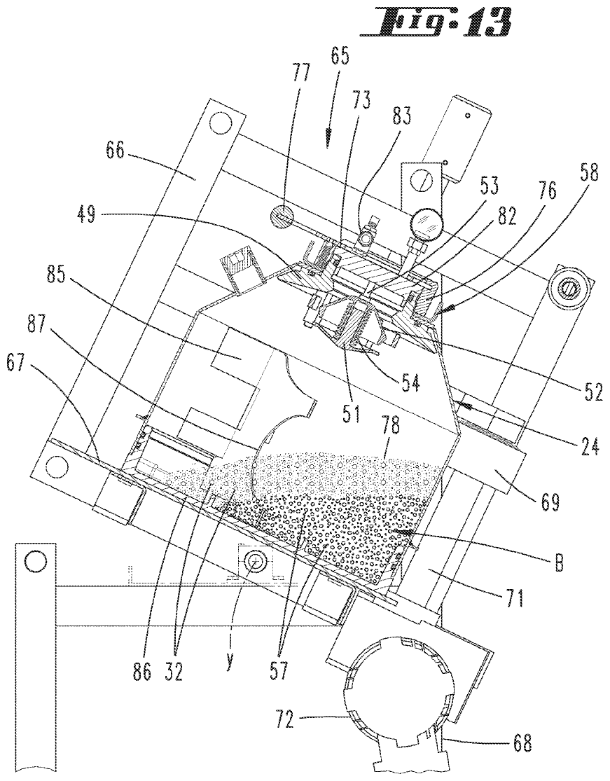

As further shown in particular in FIG. 14, by inserting and fixing a suitably shaped sheet metal part, a mixing blade 85 can be provided in the collecting chamber 24, which mixing blade, with respect to a substantially circular plan view of the collecting chamber 24, passes through the latter approximately along a diameter line and, starting from the chamber base 86, extends approximately over the axial height of a circular cylindrical chamber portion.

The mixing blade 85 is preferably secured, for example welded, to the inside of the chamber wall.

With regard to its planar extent, the mixing blade 85 preferably has a central opening 87. This opening can have an oval basic shape, with a shorter axis running in the direction of the longitudinal axis x and a longer axis running transverse thereto, wherein the dimension of the longer axis can correspond to about 0.5 to 0.8 times the free inner diameter dimension of the collecting chamber 24 in the region of the mixing blade 85 and the dimension of the shorter axis can correspond to about 0.5 to 0.9 times the longer axis.

After this first mixing cycle, but if necessary also possibly in superposition therewith, a negative pressure is preferably generated in the collecting chamber 24 via the pipeline 83, further in particular via a vacuum pump connected thereto, which, more preferably, is a component of the station 65, in particular of the receiving device 66. The associated shutoff valve 84 is open for this purpose.

At least in this evacuation situation, the chamber-side gate valve 51 is preferably kept in the open position, for which purpose the lid 58 in the attached position acts on the valve cone 52 via a holding-down means 53 against the restoring force of the compression spring 54 at the valve.

When a sufficiently large negative pressure is reached in the collecting chamber 24, the vacuum port is closed and a fluidic connection to the environment is opened via a micro throttle, and the rotating process of the pivoted collecting chamber 24 is restarted, provided that it was stopped for evacuation.

Due to the intensive mixing with the comparatively fine solid material 57, only a small amount of filtered material 32 reacts at the resulting surface 78 (compare FIG. 16) with the atmospheric oxygen from the surrounding atmosphere, which flows in very slowly and in a controlled manner, for example via the micro throttle. Accordingly, a passivation of the filtered material 32 is successively carried out in the collecting chamber 24.

As a result of the proposed and described method, a large proportion of the filtered material 32 at risk of fire is enclosed in an airtight manner by the fire prevention agent B, in this case in particular the solid material 57, when the filtered material collecting chamber 24 is arranged in the mixing station. Only a small portion on the surface of the filtered material-solid material mixture reacts with atmospheric oxygen at any one time. The reaction for passivation takes place correspondingly slowly, so that the temperature increase in the collecting chamber 24 which takes place due to the reaction is comparatively small, so that the resulting heat can be dissipated to the environment solely via the housing walls.

In the case of an exemplary holding volume of the filtered material collecting chamber 24 of about 20,000 cm³, such a passivation as a result of mixing and simultaneous supply of atmospheric oxygen can be carried out over a period of time ranging, as a further example, from 2 hours up to 12 hours or more.

Upon completion of this passivation process, the rotary drive is stopped and the receiving device 66 is pivoted back about the pivot axis y into the starting position, so that the collecting chamber 24 standing freely on the placement floor 67 is ready for further transport.

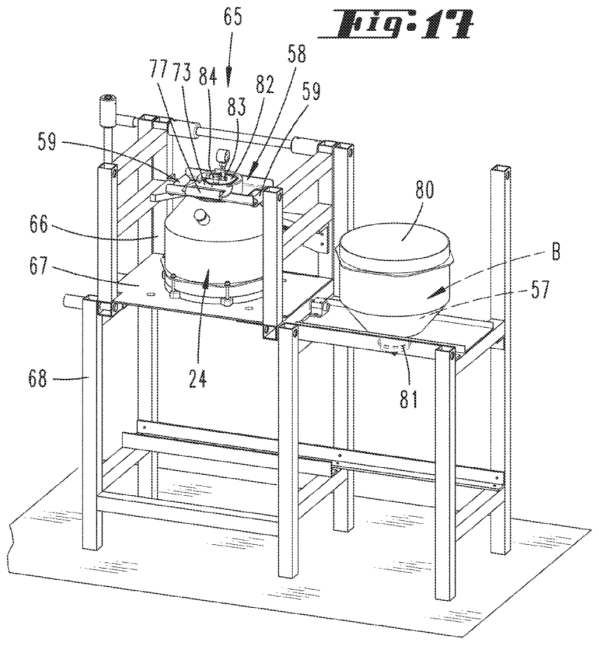

This further transport to a transport container 74 is also preferably carried out via the vehicle 60. For this purpose, the collecting chamber 24 is preferably gripped again by the fork arms 64 in the region of the handling parts 59. Subsequently, if necessary in the course of the movement of the vehicle 60 towards the transport container 74, the fork arms 64 are pivoted together with the collecting chamber 24 by preferably 180 degrees about a geometric pivot axis z directed transverse to the vertical extent of the lifting mast 63 so that thereafter, the chamber opening 50 of the collecting chamber 24 faces downwards (compare FIG. 19).

If necessary, after lifting the fork arms 64 and the collecting chamber 24 carried in this manner along the lifting mast 63 in a direction h vertically upwards, the transport container 74, into which the contents of the collecting chamber 24 are emptied, is approached.

In the region of its filling opening, which is not shown, the transport container 74 is provided with a pipe-like adapter portion 75 which is preferably designed for sealingly interacting with the sleeve portion 49 or the chamber opening 50 of the collecting chamber 24. In this respect, it is preferable to enable a tight connection, such as also substantially results between the collecting chamber 24 and the gate portion 23 of the filter device 2.

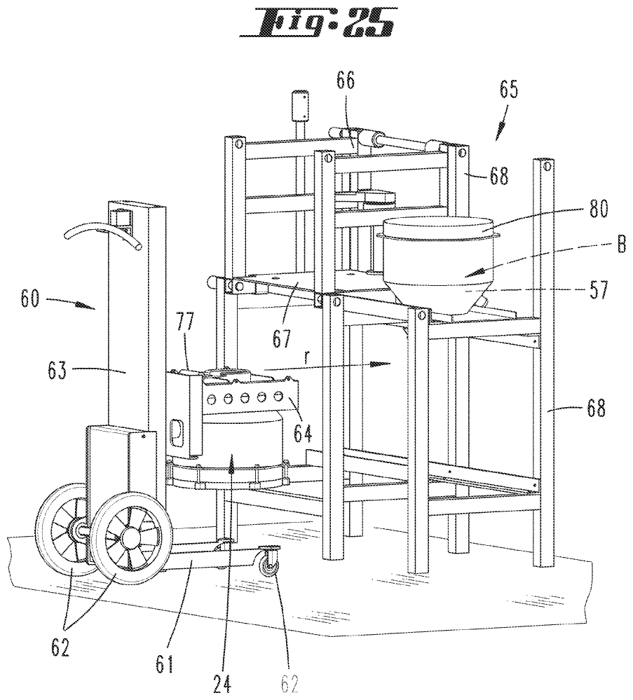

According to the schematic illustration in FIG. 24, the collecting chamber 24 is docked onto the adapter portion 75 by appropriate approach of the collecting chamber 24 using the vehicle, so that the passivated filtered material 32 received in the collecting chamber 24 and mixed with solid material 57 can be transferred, preferably solely in a gravity-dependent manner, via the chamber opening 50 into the space 79 of the transport container 74 which, in any case, is sealed off from the surrounding atmosphere.

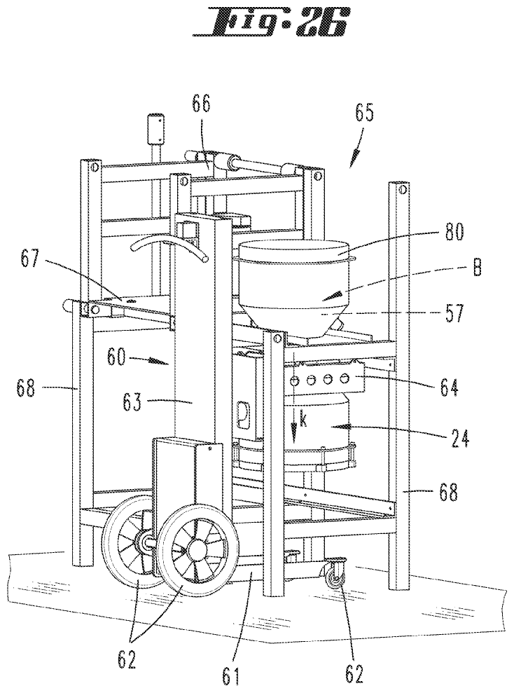

The collecting chamber 24 emptied hereafter is fed again to the station 65 by means of the vehicle 60 after the collecting chamber 24 has been turned back into the initial position, but now for refilling the collecting chamber 24 with solid material 57 (cf. FIG. 25).

For this purpose, a storage container 80 with fire prevention agent B, for example solid material 57, can be provided in the station 65, for example adjacent to the receiving device 66, with a preferably lockable adapter portion 81 pointing vertically downwards. Accordingly, the collecting chamber 24 is led to the storage container 8 at the underside thereof, wherein finally, by lifting the collecting chamber 24 vertically upwards, docking of the collecting chamber 24 with its sleeve portion 49, optionally with the lid-side connecting piece 76, to the adapter portion 81 is achieved.

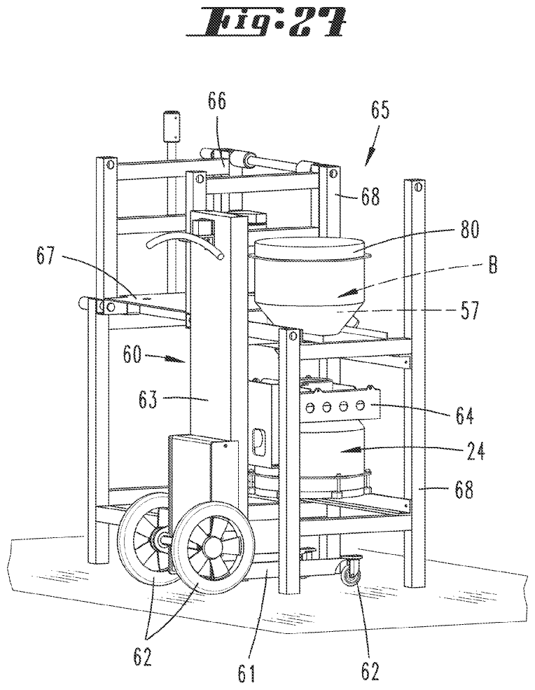

If necessary, a preferably predetermined amount of solid material 57 can be transferred, preferably in a gravity-dependent manner, from the storage container 80 into the collecting chamber 24 by targeted release, for example slide-like opening of the adapter portion 81 (compare arrow k in FIG. 26).

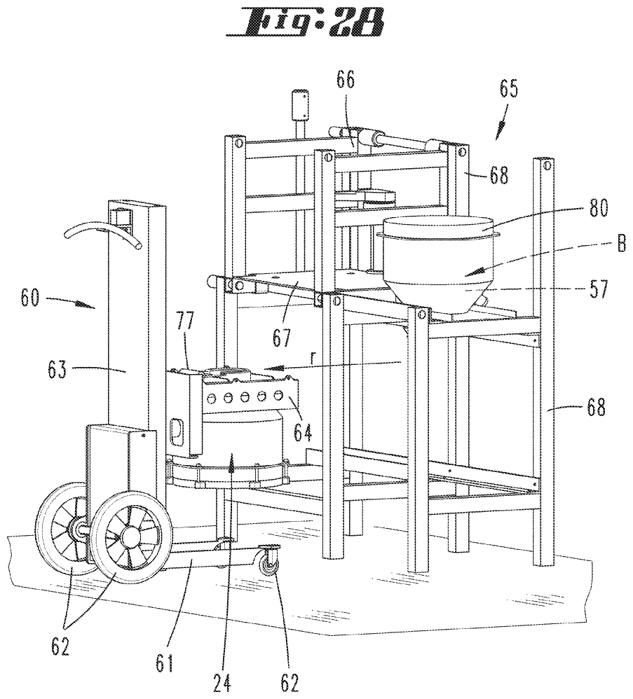

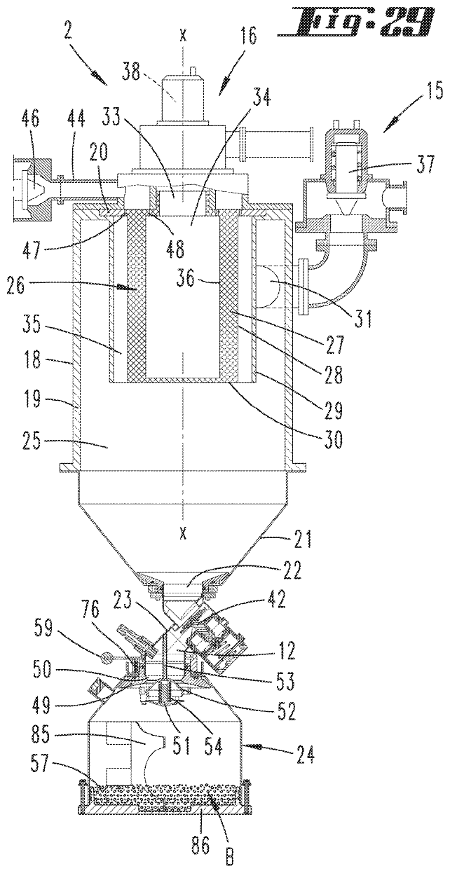

The collecting chamber 24, refilled with solid material 57, can then be transported back to the filter device 4 by means of the vehicle 60, if necessary after lowering according to FIG. 27, and arranged there again (compare FIGS. 28 and 29).

Also, during the passivation and disposal process, the filter device 2 can be equipped with an exchange collecting chamber 24 to enable further filter operation.

Insofar as reference is made above to process gas, the process gas can be a different medium if the filter device is used in connection with a different medium to be cleaned, that is, in particular, if it is used in a context other than that of a metal printing device.

### REFERENCE LIST

1 metal printing device

2 filter device

3 filter module

4 enclosure

5 laser device

6 door

7 medium

8 circulation fan

9 pressure line

10 suction line

11 medium cooler

12 channel portion

13 pot portion

14 housing

15 medium inlet

16 medium outlet

17 suction transfer line

18 filter housing

19 housing wall

20 housing ceiling

21 housing base

22 base opening

23 gate portion

24 filtered material collecting chamber

25 interior

26 filter

27 filter wall

28 outer surface

29 guide wall

30 end face

31 inlet opening

32 filtered material

33 outlet opening

34 filter interior

35 annular space

36 inner surface

37 shutoff valve

38 shutoff valve

39 control electronics

40 throttle valve

41 vacuum pump

42 discharge valve

43 flushing medium reservoir

44 flushing line

45 flushing medium

46 control valve

47 flushing medium inlet

48 flushing medium inlet

49 sleeve portion

50 chamber opening

51 gate valve

52 valve cone

53 holding-down means

54 compression spring

55 inlet

56 outlet

57 solid material

58 lid

59 handling part

60 vehicle

61 chassis

62 wheel

63 lifting mast

64 fork arms

65 station

66 receiving device

67 placement base

68 base frame

69 drive roller

70 support roller

71 shaft

72 electric motor

73 slider

74 transport container

75 adapter portion

76 collar

77 handle

78 surface

79 space

80 storage container

81 adapter portion

82 ceiling portion

83 pipeline

84 shutoff valve

85 mixing blade

86 chamber base

87 opening

a direction

b direction

c direction

d direction

e arrow

f direction

g arrow

h direction

k arrow

r approach direction

x longitudinal axis

y pivot axis

z pivot axis

B fire prevention agent

1. A method for cleaning a filter (26) in a filter device (2) having a filter housing (18) and the filter (26) located therein, the filter device (2) having a filtered material collecting chamber (24) for receiving filtered material (32) which accumulates in the course of cleaning the filter (26), the method comprising the steps of:
filling the filtered material collecting chamber (24) with a fire prevention agent (B) before a first receipt of filtered material (32), for which purpose the filtered material collecting chamber (24) is filled with a solid material (57) over part of the volume of the filtered material collecting chamber (24),
in the course of a removal of the filtered material collecting chamber (24) from the filter device (2), carrying out a targeted exchange of a chamber atmosphere for the surrounding atmosphere, and
in connection with an inflow of atmospheric air, carrying out a mixing movement of the filtered material collecting chamber (24) for mixing the filtered material (32) with the solid material (57).

2. The method according to claim 1, wherein the filtered material collecting chamber (24) is filled with a gas for fire prevention.

3. The method according to claim 1, wherein the filtered material collecting chamber (24) is filled with a protective gas for fire prevention.

4. The method according to claim 1, wherein the solid material (57) is granular.

5. The method according to claim 1, wherein the solid material (57) glass-like.

6. (canceled)

7. The method according to claim 1, wherein the filtered material collecting chamber (24) is removed from the filter device (2) after a predetermined filling level of filtered material (32) in the filtered material collecting chamber (24) is reached and the protective gas is exchanged for atmospheric gas.

8. The method according to claim 7, wherein the exchange, with regard to a volume of the filtered material collecting chamber (24) receiving a filtered material (32) of 10,000 to 25,000 cm³ or more, is carried out over a period of time ranging from 2 hours up to 12 hours or more.

9. (canceled)

10. The method according to claim 1, wherein the filtered material collecting chamber (24) removed from the filter device (2) is connected to a transport container (74), and wherein the filtered material (32) is transferred directly into a space (79) of the transport container (74) which, in any case, is shut off from the atmosphere.

11-15. (canceled)
